(19) United States
(12) Patent Application Publication
(10) Pub. No.: US 2010/0138746 A1
(43) Pub. Date: Jun. 3, 2010

(54) SYSTEM AND METHOD FOR SYNCHRONIZED VIDEO SHARING

(76) Inventor: Rony Zarom, New York, NY (US)

Correspondence Address: Pearl Cohen Zedek Latzer, LLP, 1500 Broadway, 12th Floor, New York, NY, 10036, US

(21) Appl. No.: 12/523,993

(22) PCT Filed: Jul. 20, 2008
(86) PCT No.: PCT/IL08/01005

§ 371 Date: Jul. 21, 2009

Related U.S. Application Data
(60) Provisional application No. 60/960,751, filed on Oct. 12, 2007.

(51) Int. Cl. G06F 3/048; G06F 15/16

(52) U.S. Cl. 715/720; 715/738; 709/203; 715/760

(57) ABSTRACT

A system and a method for synchronized sharing of digital content through a network.

### FIELD OF THE INVENTION

The present invention relates to a system and a method for digital data sharing, and in particular, to such a system and method which enable such data display to be synchronized on a plurality of computers over a network.

### BACKGROUND OF THE INVENTION

The Internet has enabled computer users all over the world to interact and communicate electronically. For example, users can send and receive e-mail messages, view Web pages, download music, software, videos and perform many other activities.

Video data is particularly popular for transmission through the Internet. Popular video sharing Web sites such as YouTube, MetaCafe and the like enable users to upload user-created video content for sharing with viewers through the Internet. Such users may be private individuals who create video content as amateurs. These amateur video content creators may be paid by the Web site, for example by sharing of advertising revenues generated when viewers choose to view a particular video and at the same time are provided with advertisement(s) to watch.

Users may also be corporations and/or advertising agencies who attempt to create “viral” advertisements. A “viral” advertisement is one which is viewed voluntarily by viewers, rather than being imposed on viewers who wish to watch something else (as in the example of television programs). Some highly successful viral advertisements have caused viewers to even search for locations on the Internet to download and view the advertisement, thus providing millions of dollars worth of free publicity to their creators.

Thus, whether from amateur video content creators or from professional advertising companies (or other corporations or organizations), video content sharing websites are receiving increasing amounts of such video content for display. However, currently a user who wishes to view video content with another user at a remote location cannot easily have a completely shared experience. For example, if one user wishes to stop the video to examine a frame, to “rewind” (go backward in the stream) or “fast forward” (go forward in the stream), the video content for that user will no longer be synchronized with that of the other user.

Other possible implementations of sharing data via the network are for various types of group activities, for example for business, educational or other purposes, when two or more parties would like to discuss a data such as a movie, document, one or more images, or a presentation or any other digital data.

Synchronization is not difficult for two devices which are in a physically similar location, as described for example in US Application No. 2007/0136769. In this Application, one video device transmits video data to another video device in order to control synchronization. Although this type of sharing has been proposed for the Internet, it is clearly inefficient, since the video data is effectively transmitted from a server to a first computer and from there to a second computer.

PCT Application No. WO 2007/079334 describes another type of synchronized system, in which a host computer is connected to a plurality of client devices. However, the client devices are described as being dedicated video players, while the host computer is described as operating media software such as the iTunes® software of Apple Computer Inc. Such a system would be suitable in a house for example, to allow a user to broadcast media on a private network. It does not solve the problem of allowing remote users to synchronize digital content, such as video, through a network such as the Internet.

Currently available solutions permit broadcasting of data from a single computer; the user of that computer can then control the display. However, synchronization over a plurality of computers without such broadcasting of the actual data to be displayed is not possible with currently available solutions, but only through the present invention.

### SUMMARY OF THE INVENTION

There is an unmet need for, and it would be highly useful to have, a system and a method for enabling synchronized digital data to be efficiently shared on a plurality of computers.

There is also an unmet need for, and it would be highly useful to have, a system and a method for sharing such digital data while controlling and synchronizing the displaying of the data on a plurality of computers through the network.

There is also an unmet need for, and it would be highly useful to have a system and method that enables the control of data display by all the participants.

The present invention overcomes the drawbacks of the background art by providing a system and method for synchronized sharing of digital data through a network. Non limiting examples of such digital data include video, audio, documents, one or more images, or presentations.

According to some embodiments, the invention is implemented by a web site which enables communities to share data content.

According to other embodiment the invention is implemented by an application which communicates over the network via peer to peer protocol.

The application, whether implemented as a web site, or as a peer to peer application, is handled by sessions. The members of the session can be any of the community members (in the case of a web site implementation) or any of the computers participating in peer to peer communication. Each session preferably starts by one of the members. For the purpose of illustration only the initiator of the call is hereinafter called the initiator. The initiator optionally opens a session by inviting other members to join the session. During the session members can join or leave the session. The session is optionally and preferably terminated when the initiator leaves.

According to other embodiments of the present invention, the application enables each member of the session to share his or her digital content by, for example, placing the content in a shared place which can be accessed by all the members of the session. Placing the content at a shared location may optionally be performed, for example, by placing the URL (Uniform Resource Locator; or other address information) to the content at the shared location, or by pointing to content that is located at the user's own computer. In the latter case, the content is preferably uploaded to the server. The uploading is preferably transparent to the user.

According to still other embodiments of the present invention, the session initiator preferably controls the session. The session initiator can optionally and preferably delegate control of the session to one or more members of the session. Control of the session optionally and preferably comprises starting to play one of the shared content, stopping or pausing the playing, rewinding or moving forwards; in the case of a document or presentation or photo album or any other multipage document, it optionally and preferably comprises going to the next page or slide, going to the previous page or slide or jumping to a specific page or slide.

According to this embodiment, whenever one of the controllers performs one of these commands, the command is transferred to all the other members using, for example, HTTP protocol (or any of the peer to peer protocol in the case of peer to peer implementation). The command optionally and preferably causes the video/audio content to be simultaneously played/stopped/paused/moved forward/rewound in all the computers of the members who participate in the session. It should be understood that these commands are given as an example only, and other commands may be also provided by the system and method of the present invention.

According to other embodiments of the present invention, the data content is kept by one or more content service devices. The current played content is optionally and preferably transmitted from the content service device to all the computers that participate in the session. The content is played on each computer by the player which is part of the invention. The controlling commands are preferably transmitted from the player of one of the computers who participate in the session to all the players in the other computers.

According to other embodiments of the present invention, the participants of the session can optionally and preferably communicate during the session via chat, video/audio conferencing, voice over IP or any other communication over the network. The application optionally and preferably enables each participant to display his or her own picture during the session.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a smart mobile telephone, a PDA (personal data assistant), a pager, TV decoder, game console, digital music player, ATM (machine for dispensing cash), POS credit card terminal (point of sale) or an electronic cash register. Any two or more of such devices in communication with each other, and/or any computer in communication with any other computer may optionally comprise a “computer network”.

Whenever the present invention is described with regard to a video data, it should be noted that optionally any digital data including but not limited to music, slide show, documents, images and so forth may be described as video data.

Hereinafter “online” refers to communication performed through an electronic communication medium, including but not limited to, data transmission through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; transmitting video data over any type of network; any type of communication using a computational device as previously defined; as well as any other type of communication which incorporates an electronic medium for transmission.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary system according to the present invention;

FIG. 2 shows an exemplary embodiment of a digital data sharing software application display according to the present invention;

FIG. 3 is an exemplary diagram of the scenario in which a movie is synchronized by the players;

FIG. 4 is an exemplary of a web page that is used for activating the application in the case that the invention is implemented by a web site; and

FIG. 5 is an exemplary diagram of a command structure.

### DESCRIPTION OF THE PREFERRED EMBODIMENTS

The present invention is of a system and a method for synchronized sharing of sensory data, preferably video data, through a network. Synchronization preferably occurs through video display software, such as media software, being operated by a computer on the network, while receiving streaming video data from a video provider, such as a server for example. The media software preferably sends commands from one of the computers on the network directly to one or more other computers.

Other types of sensory data which may optionally be displayed in a synchronized manner according to other embodiments of the present invention include but are not limited to, image data, music or other audio data and the like. Image data could optionally include for example photographs, as for an on-line photograph album for example.

The principles and operation of the present invention may be better understood with reference to the drawings and the accompanying description. It should be noted that the Figures below show an embodiment of the present invention with regard to sharing video data for the purpose of description only and without any intention of being limiting in any way.

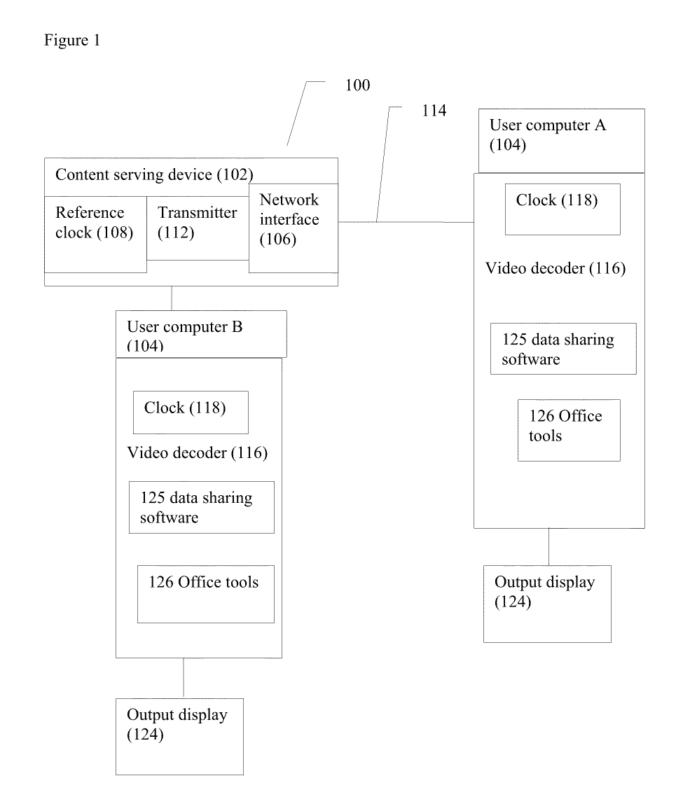

Referring now to the drawings, FIG. 1 is a schematic block diagram of an exemplary, illustrative system according to the present invention. As shown, a system 100 features a content serving device 102, such as a server for example. Content serving device 102 preferably enables video/audio data to be streamed through a computer network 114, such as the Internet for example but which may optionally be any type of network as described herein. Content serving device 102 preferably enables video/audio data to be streamed through a computer network 114, such as the Internet for example but which may optionally any type of network be as described herein. Content serving device 102 preferably also enables multipage documents to be transferred through computer network 114. Content serving device 102 can optionally belong to a content service provider.

Content serving device 102 preferably features a transmitter 112 for optionally and preferably transmitting video data, which is typically (and preferably) in an encoded format. Transmitter 112 preferably performs any necessary processes for transmitting video data over computer network 114, for example by preparing the video data for transmission according to the video over IP standard. Transmitter 112 preferably transmits the video data through a network interface 106 as shown.

Transmission is optionally and preferably performed according to a standard for transmission of video data over a computer network. Non-limiting examples of such standards include H.323, RTP (Real-time Transport Protocol), Real-Time Streaming Protocol (RTSP) and SIP (Session Initiation Protocol which is preferably used for video conferencing). It should be noted that RTP may optionally be used in combination with H.323 and/or SIP. Audio data may optionally be transmitted according to an appropriate protocol. Transfer of multipage documents is optionally and preferably performed according to a standard for transmission of such data including but not limiting to HTTP (hypertext transfer protocol), HTTPS (secure HTTP) and the like.

Timing of such video transmission is preferably controlled by a reference clock 108, which may optionally be implemented as any type of real time as is known in the art, and may also optionally be implemented as hardware, software or firmware, as is known in the art.

A plurality of user computers 104 are preferably connected to computer network 114 as shown, labeled as “user computer A” and “user computer B” for clarity. Of course, any number of user computers 104 may optionally be connected to computer network 114. Each user computer 104 preferably features a video decoder 116, which receives the transmitted video data and prepares the data for being viewed on an output display 124. Video decoder 116 may optionally be implemented as any type of media application as is known in the art, and may for example be implemented as iTunes® software for media file management and playback produced by Apple Computer, Inc., and/or as the Windows® media player (Microsoft Inc).

Timing of the operation of video decoder 116, and hence of the display of the video data, is optionally and preferably controlled through a clock 118, which may optionally be implemented as any type of real time as is known in the art, and may also optionally be implemented as hardware, software or firmware, as is known in the art.

Each clock 118 as described above is preferably synchronized by using Network Time Protocol (NTP) to initially synchronize local clocks with reference clock 108 at video serving device 102.

According to an exemplary embodiment of the present invention, user computer 104 “A”, who, in this example, is the session initiator, preferably sends a request over the network to content serving device 102 in order to initiate synchronized playback. User computer 104 “B” may optionally receive the request directly from user computer 104 “A”, or alternatively and optionally may receive the request from content serving device 102. After session initiation User computer “A” may optionally delegate the ability to control the session to User computer “B”. Clocks 118 and reference clock 108 are preferably synchronized as described above.

For the purpose of this example, user computer 104 “A” controls the playback. For the purpose of this example, the shared content is video content. Content serving device 102 preferably starts streaming the video data to both user computers 104. Optionally and preferably, both video decoders 116 at user computer 104 “A” and at user computer 104 “B” buffer the video data, to prevent network “jitters” and also to more easily enable synchronization. Display of the video data is then preferably initiated at output displays 124 of user computer 104 “A” and user computer 104 “B”.

If video sharing software 125 at user computer 104 “A” is instructed to alter the flow of video data, for example through activation of the “stop”, “pause”, “rewind” and/or “fast forward” functions, a command is preferably sent to user computer 104 “B”. Video decoder 116 at user computer 104 “B” then obeys the command in order for the display of video data to remain synchronized with the display at user computer 104 “A”. For example, if the command is to “stop”, then video decoder 116 at user computer 104 “B” stops playing back the video data.

The command is preferably sent directly from video decoder 116 at user computer 104 “A” to video decoder 116 at user computer 104 “B”. Commands are preferably sent according to a peer to peer protocol, although commands may also optionally be transmitted through content serving device 102. For this embodiment, preferably sufficient buffering is provided of both previously displayed video data and video data to be displayed in the future in order to support commands such as “rewind” and “fast forward”.

According to some embodiments, both user computer 104 “A” and user computer 104 “B” may optionally send commands to each other, for the control of the respective video decoders 116. It should be understood that only two users are described in the diagram for the purpose of illustration only and that the system and method can optionally handle more users. In this case the computer that currently controls the session preferably sends commands simultaneously to all the other computers. It should be noted that the video is used here as an example only and in the case of multipage data the office tools 126 are preferably provided to assist with performing one or more commands (for example, to move to a particular page or other unit of data). Preferably, each session could include displaying a plurality of units of digital content, such as a plurality of video clips, a plurality of songs and the like, and/or a combination thereof, without requiring the session to be restarted.

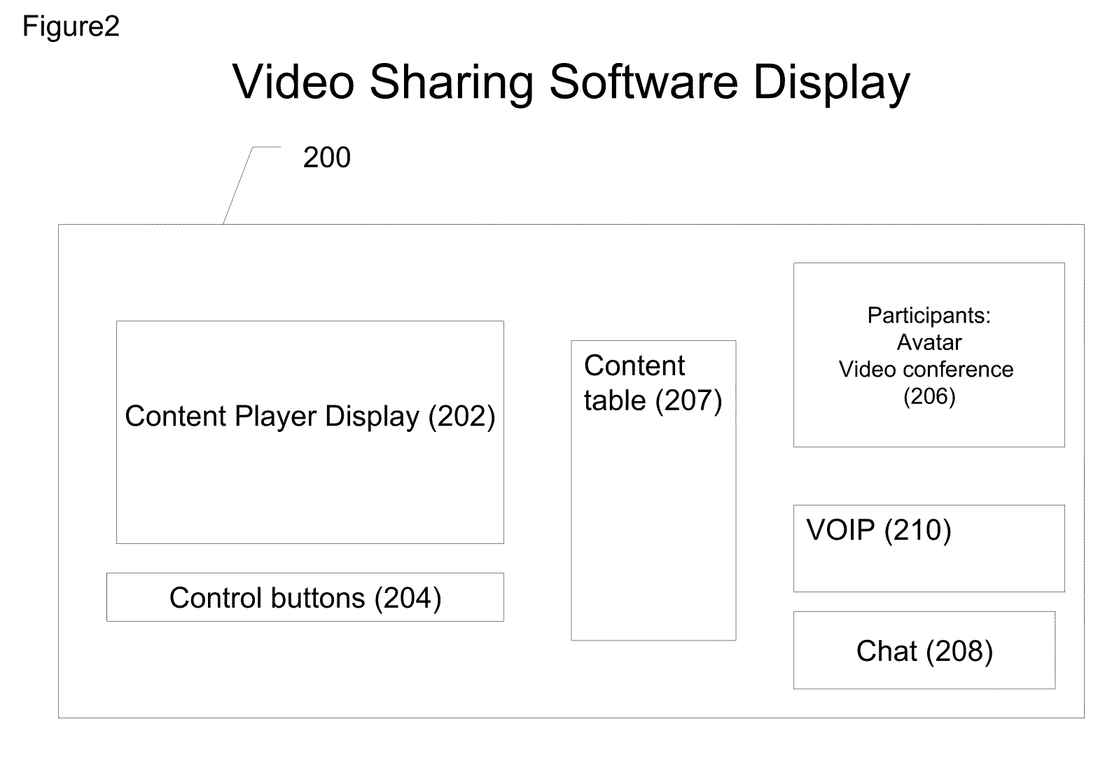

FIG. 2 shows an exemplary embodiment of a video sharing software display 200 according to the present invention. Display 200 is optionally implemented as a web page, when the application is implemented through a website. Display can also be implemented as a window, using one of the existing operating systems such as Microsoft windows. Display 200 preferably features a content player display 202 for displaying the received data, for example video data, image data and/or audio data. For the latter, the “display” may optionally include being played through loudspeakers or other audio equipment, for example.

Display 200 optionally features one or more control buttons 204, for operating the control commands. When the content is audio or video, control buttons can be for example play, to start playing the content, rewind, forward and stop. When the content is a multipage document, control buttons can be, for example, start, to start displaying the document, next for going to the next page, previous for going to the previous page and go-to for jumping to a specific page. Control commands are preferably sent over P2P (peer to peer) protocol although they may optionally be sent through a central server. Control commands also include the commands for inviting other member for the sessions and for delegating the ability to control the session to other members. The latter commands are preferably available only for the initiator of the session (the user who initiates the session).

Optionally and preferably, display 200 features a participant display 206, showing a visual display of one or more participants in the video sharing session and/or a corresponding avatar. If the former, the visual display could optionally be used to confirm that all participants are still viewing the data, for example, and/or to provide body language feedback.

A chat module 208 and voice over IP module 210 are also optionally and preferably provided for enabling the users of the various computers showing the video data to communicate, for example to exchange information and/or opinions regarding the data being displayed. The content table 207 is preferably used for displaying all the shared content. This table can optionally displays URLs of video, clips, documents and the like that are shared between the participant of the session. The URLs can optionally be displayed as thumb nail images. Each participant who is authorized to control the session can optionally choose one of the content and from this table ad start playing this content.

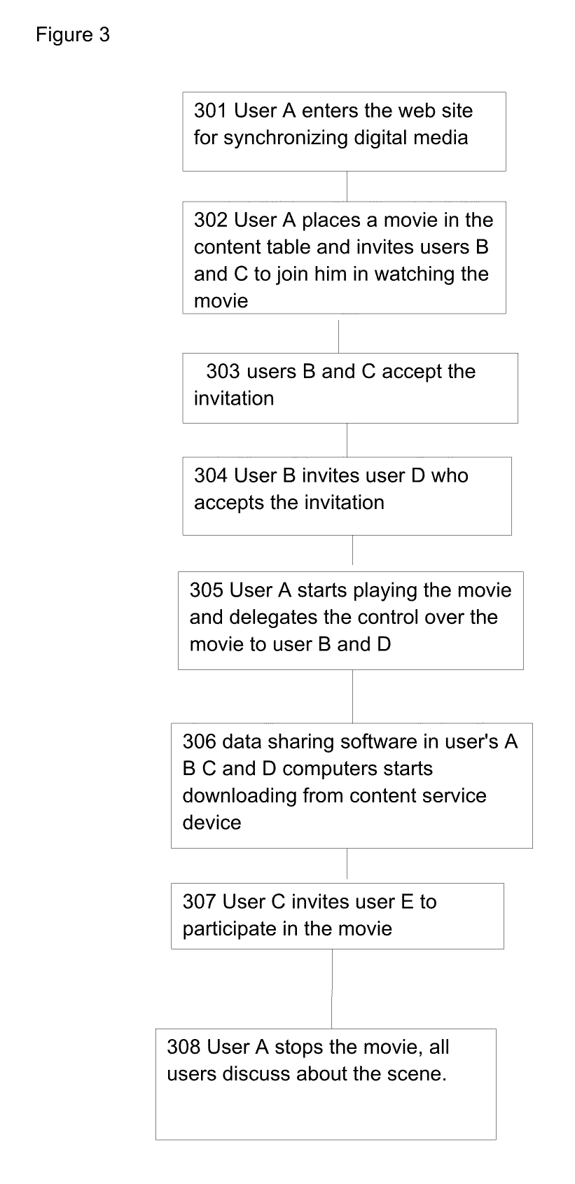

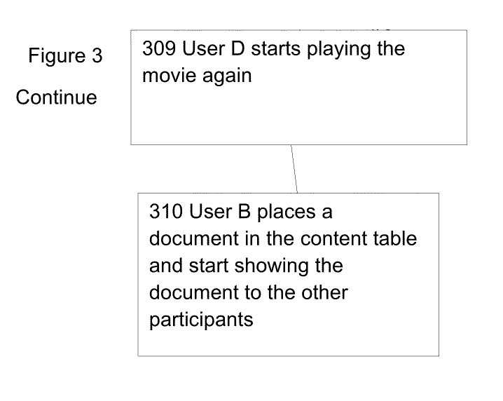

FIG. 3 is an exemplary diagram of the scenario in which a movie is synchronized by the players. It should be noted that the internet implementation is described for the purpose of description only and without any intention of being limiting and any other implementation of the application can be used. The synchronization can be optionally implemented via a web site in which communities can be created. Each community can optionally handle sessions in which digital media content, such as movie, is being shared and synchronized by the members of the session. According to this embodiment, one of the users opens the session by inviting other to watch a movie, for example. The initiator can manually delegate the ability to control the movie to other users. In other embodiments, control over display of the movie can automatically be shared by all the participants of the sessions. In the drawing: first user A enters the web site for synchronizing digital media (301). Then user A places a movie in a shared place (referred to as content table 207 in FIG. 2). Preferably placing the movie in the shared place causes the movie to be shared by all the participants of the session. Then user A invites user B and C to join the session (302). Invitation is optionally and preferably done using P2P protocol. Users B and C accept the invitation (303). During the session any of the participants can invite other members to participate. In this scenario user B invites user D to participate in the session. User D accepts the invitation (304).

User A, who is the initiator of the session, can permit one or more other members to also control the session. In this scenario user A starts playing the movie and delegates the control over the movie to users B and D, by using the control commands (305). As a result of the play command, data sharing software in the computers of all the participants of the session starts downloading from the content serving device (306). While the movie is played user C invites user E to participate in the movie (307). Since the control commands of the data sharing software can refer to the current frame, user E starts watching the movie from the current played frame. In the next stage user A stops the movie and all users discuss the scene (308). Discussion can be implemented via chat, video conferencing, voice over IP, or any other method for implementing a discussion over the network. When discussion is finished user D, who also has the ability to control the play, starts playing the movie again (309). When movie ends user B places a document in the shares area and starts showing the document to the others (310). During the session some participants may optionally leave the session, while others may optionally join.

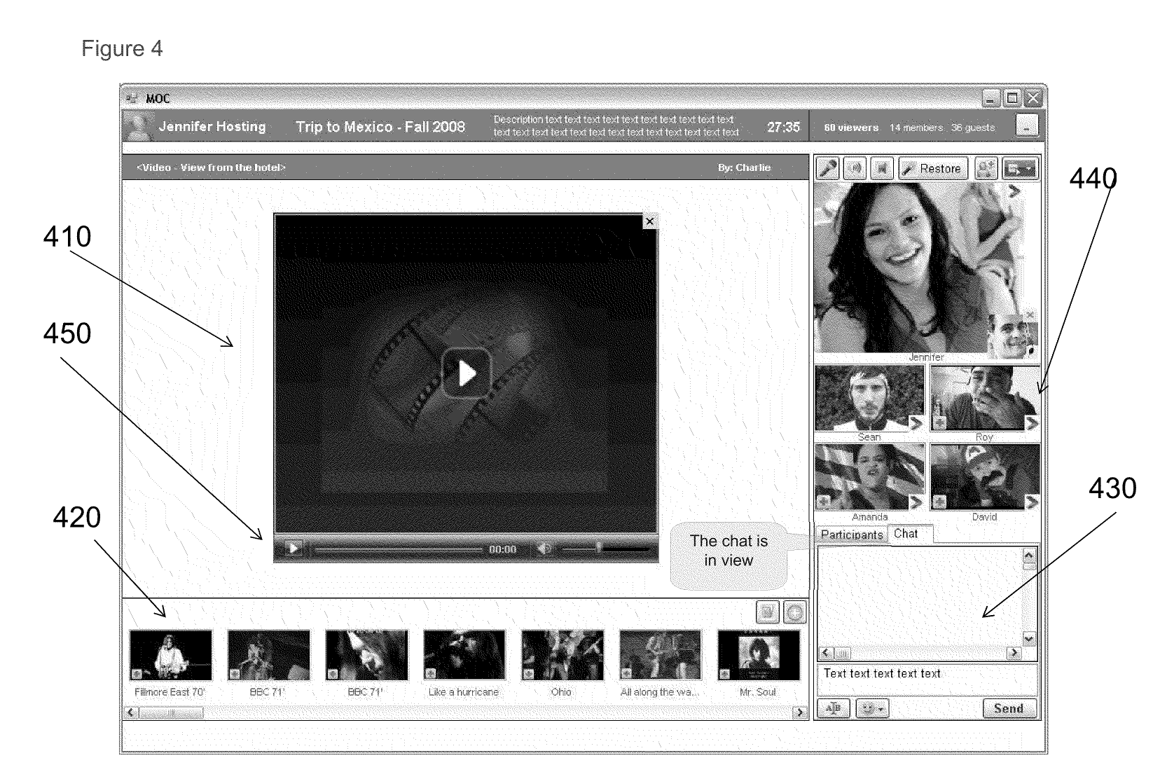

FIG. 4 is an exemplary illustration of a web page that is used for activating the application in the case that the invention is implemented by a web site. As shown in the figure, the page features a content player display which includes the display of the current running content 410, control buttons 450 for controlling the running content and a content table featuring a list of content data 420. The web page also features conferencing area with the display of the participants' avatars 440 and chat area 430.

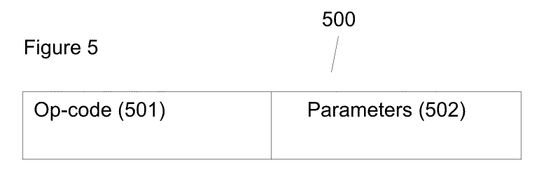

FIG. 5 is an exemplary diagram of the command structure. The commands are sent over the network, preferably through a peer to peer protocol (although optionally through a central server), and are used for synchronizing the playing of a digital content, for example for starting, stopping, or rewinding a movie which is currently shared by some players. Referring now to the drawing; a command structure 500 is preferably and optionally composed of an op-code 501 and parameters 502. Op-code 501 is the operation code of the command that has to be performed. Op-code 501 can be, for example, commands such as play movie, rewind movie, forward movie show photo, next photo, previous photo, show document, next page, previous page, go to page number and the like. The parameters 502 can be, for example the URL that is used for referring to the content, the frame number in which the movie should be stopped, or to which the movie should be rewind (in the case of a content being a movie), the page number (in case of a document) and the like. Command structure 500 may optionally be a string or any other message structure, preferably according to the protocol used to transmit the command.

While the invention has been described with respect to a limited number of embodiments, it will be appreciated that many variations, modifications and other applications of the invention may be made.

1. A method for synchronizing display of digital content, comprising:
Providing a plurality of user computers connected to a content serving device through a network, each user computer comprising a media player for displaying the digital content;
Transmitting the digital content from said content serving device to each user computer;
Synchronizing display of the digital content between said user computers;
Transmitting a command by a user computer to at least one other user computer to alter a flow of transmission of said digital content; and
Altering said flow of transmission of said digital content on at least one other user computer according to said command.

2. The method of claim 1 wherein the said digital content is selected from the group consisting of video data, a digital document, a plurality of images and a presentation.

3. The method of claim 1 wherein said command includes one or more of starting the display, stopping the display, moving forward or backwards, or jumping to a certain page of a digital document.

4. The method of claim 1 wherein the said communication is implemented by at least video conferencing, voice over IP and chat.

5. The method of claim 4 further comprising:
Uploading the digital content to said content serving device from one of said user computers.

6. The method of claim 5, wherein said uploading said digital content is performed through a mark-up language document interface.

7. The method of claim 6, wherein said mark-up language document interface comprises a web page.

8. The method of claim 7, further comprising:
Inviting a plurality of users operating user computers to join a session by an initiator through a user computer of said initiator wherein said command to alter said flow of said transmission is sent by said user computer of said initiator, or by said user computer of one or more of said invited users who are authorized by the said initiator to control said flow of said transmission.

9. The method of claim 8, wherein said command for controlling said transmission is sent according to a peer to peer application.

10. The method of claim 1 wherein said display comprises a visual display.

11. The method of claim 1 wherein said display comprises an audio display.

12. A system for synchronizing the display of shared digital content over the network, comprising;
A plurality of user computers, connected via network, for displaying and controlling said synchronized digital content; each user computer comprising a media player for playing video and or audio data and an office tool for displaying documents; and
A content serving device, connected to said plurality of computer via network, for simultaneously transmitting said digital content to said plurality of computers, wherein at least one user computer sends a command for altering transmission of said digital content to said plurality of computers.
